(19) United States
(12) Patent Application Publication
(10) Pub. No.: US 2015/0170513 A1
(43) Pub. Date: Jun. 18, 2015

(54) PEDESTRIAN MOTORIST ASSISTANCE DEVICE

(71) Applicant: Gerald D. Gipaya, Ewa Beach, HI (US)

(72) Inventor: Gerald D. Gipaya, Ewa Beach, HI (US)

(21) Appl. No.: 14/559,249

(22) Filed: Dec. 3, 2014

Related U.S. Application Data
(63) Continuation of application No. 29/476,694, filed on Dec. 16, 2013.
Application No. 29/476,694 is a continuation of application No. 29/480,756, filed on Jan. 29, 2014.
(60) Provisional application No. 61/916,581, filed on Dec. 16, 2013.

(51) Int. Cl. G08G 1/005

(52) U.S. Cl. CPC G08G 1/005

(57) ABSTRACT

A pedestrian motorist assistance device is configured to be mounted on a vehicle so as to be visible from at least a front part thereof. It is formed as a dual-lens light beacon assembly having a first light beacon part to be electrically coupled to a first sensor for a brake mechanism to provide a first color (red) light when the brake mechanism is being operated by the driver, and a second light beacon part to be electrically coupled to a second sensor for a gas-pedal mechanism to provide a second color (green) light when the gas-pedal mechanism is being operated by the driver. The light beacon assembly provides a positive indication to a pedestrian that the driver has seen the pedestrian and is acting to slow down or stop, so that the pedestrian can be assured of crossing a street in front of the vehicle safely.

This U.S. Patent Application claims the priority filing benefit of U.S. Provisional Application 61/916,581 filed on Dec. 16, 2013, of the same title, U.S. Design Application 29/476,694 filed on Dec. 16, 2013, entitled “Design for Vehicle Beacon for Pedestrian”, and U.S. Design Application 29/480,756 filed on Jan. 29, 2014, entitled “Design for Vehicle Beacon for Pedestrian with Flat Base”.

### FIELD OF INVENTION

The subject matter disclosed herein generally relates to a safety device to assist a motorist in avoiding an accident with a pedestrian. In particular, it is directed to a light beacon positioned on a vehicle that signals to a pedestrian whether a motorist is operating the brake or gas pedal of the vehicle.

### BACKGROUND ART

When pedestrians cross a street, particularly at a crosswalk or crossing point controlled by a traffic signal or pedestrian warning signal, the pedestrian sensing an approaching car is typically uncertain whether the driver will see the pedestrian and start to slow down or stop. Traffic statistics, for example in Year 2010, show that 4,280 pedestrians were killed and an estimated 70,000 were injured in traffic accidents with cars in the United States. On average, a pedestrian was killed every two hours and injured every eight minutes in traffic crashes.

Conspicuity devices are known that employ lamps and reflectors that make a vehicle conspicuous and visible with respect to its presence, position, direction of travel, change in direction or deceleration. Such lamps may burn steadily, blink, or flash, depending on their intended and regulated function. The lighting system of a motor vehicle typically consists of lighting and signaling devices mounted or integrated on the front, sides, rear, and in some cases the top of the motor vehicle. The purpose of the lighting system is to provide illumination for the driver to operate the vehicle safely, to increase the conspicuity of the vehicle, and to display information to external observers about the vehicle's presence, position, size, direction of travel, and driver's intentions regarding direction and speed of travel.

However, vehicle lighting systems do not provide an indication to pedestrians whether a driver has seen the pedestrian and is slowing or braking the vehicle. If a pedestrian assumes that the driver of a vehicle approaching them has seen them and assumes that the driver will yield the pedestrian the right-of-way when this is not the case, terrible accidents or even fatalities can occur.

### SUMMARY OF INVENTION

This invention seeks to solve the problem of preventing pedestrian accidents and deaths while crossing a street from a crosswalk, median strip, traffic island or even while jaywalking by providing a light beacon positioned on a vehicle that signals to a pedestrian whether a motorist is operating the brake or gas pedal of the vehicle. The intended pedestrian warning/advisory system is designed to alert pedestrians whether a driver is acting to slow or stop the vehicle so that they can cross safely.

In accordance with the present invention, a pedestrian motorist assistance device comprises a light beacon assembly to be positioned on a front part of a vehicle, having a first light beacon part to provide light of a first color, which is configured to be electrically coupled to a first sensor for a brake mechanism in the vehicle so as to actuate the first light beacon part to illuminate the first color when the brake mechanism is being operated by the driver, and a second light beacon part to provide light of a second color, which is configured to be electrically coupled to a second sensor for a gas-pedal mechanism in the vehicle so as to actuate the second light beacon part to illuminate the second color when the gas-pedal mechanism is being operated by the driver.

In a preferred embodiment, the pedestrian motorist assistance (PMA) device is configured to be mounted on a front part of the vehicle where it can be seen by a pedestrian in front of the vehicle. It may be designed as a light beacon assembly with a curved base to be installed on a curved, forward exterior leading edge of the roof of the driver/passenger compartment of automobiles and sport utility vehicles (SUV). A modified version of the light beacon assembly may have a flat base designed to be mounted on a flat part of the roof or hood of utility vehicles such as trucks and buses. The PMA device may be configured as a dual-lens assembly split horizontally to provide a red light from a top layer (for higher visibility) and a green light from a bottom layer.

With the PMA device installed on a vehicle, the following describes the scenario of its use. While a pedestrian waits at crosswalk to safely cross a roadway, the vehicle approaches and the PMA beacon is illuminated with a green light indicating the driver's operation of the gas-pedal. When the driver sees the pedestrian and acts to slow down or stop by taking his/her foot off the gas-pedal turning off the green light and pressing the brake pedal turning on the red light, the driver is providing a positive indication to the pedestrian that the driver has seen the pedestrian and is acting to slow down or stop, so that the pedestrian can be assured of continuing to cross safely.

Other objects, features, and advantages of the present invention will be explained in the following detailed description of certain preferred embodiments with reference to the appended drawings.

### BRIEF DESCRIPTION OF DRAWINGS

FIG. 1 shows a top perspective view of the PMA device having a dual-lens assembly for red and green light beacons.

FIG. 2 shows a rear perspective view of the PMA device having a rear connector port for electrically connecting the beacon assembly to sensors for the brake and gas-pedal mechanisms.

FIG. 3 shows a front view of the PMA device.

FIG. 4 shows a rear view of the PMA device.

FIG. 5 shows a side view of the PMA device.

FIG. 6 shows a top view of the PMA device.

FIG. 7 shows a bottom view of the PMA device.

FIG. 8 shows the PMA device in its intended environment of use installed on the front edge of the roof of a driver/passenger compartment of a vehicle.

FIG. 9 shows an assembly view of the PMA device.

FIG. 10 shows a modified PMA device having a flat base to be installed on the hood of an automobile.

FIG. 11 shows a modified PMA device having a flat base to be installed on the hood of a truck.

### DETAILED DESCRIPTION OF PREFERRED EMBODIMENTS

In the following detailed description of the subject matter hereof, one or more preferred embodiments are described and illustrated in the accompanying drawings with certain specific details of implementation. However, it will be recognized by one skilled in the art that many other variations and modifications may be made and/or practiced in analogous applications or environments. It should be noted that methods, procedures, components, or functions that are commonly known to persons of ordinary skill in the field of the invention are not described in detail herein so as avoid unnecessarily obscuring a concise description of the preferred embodiments.

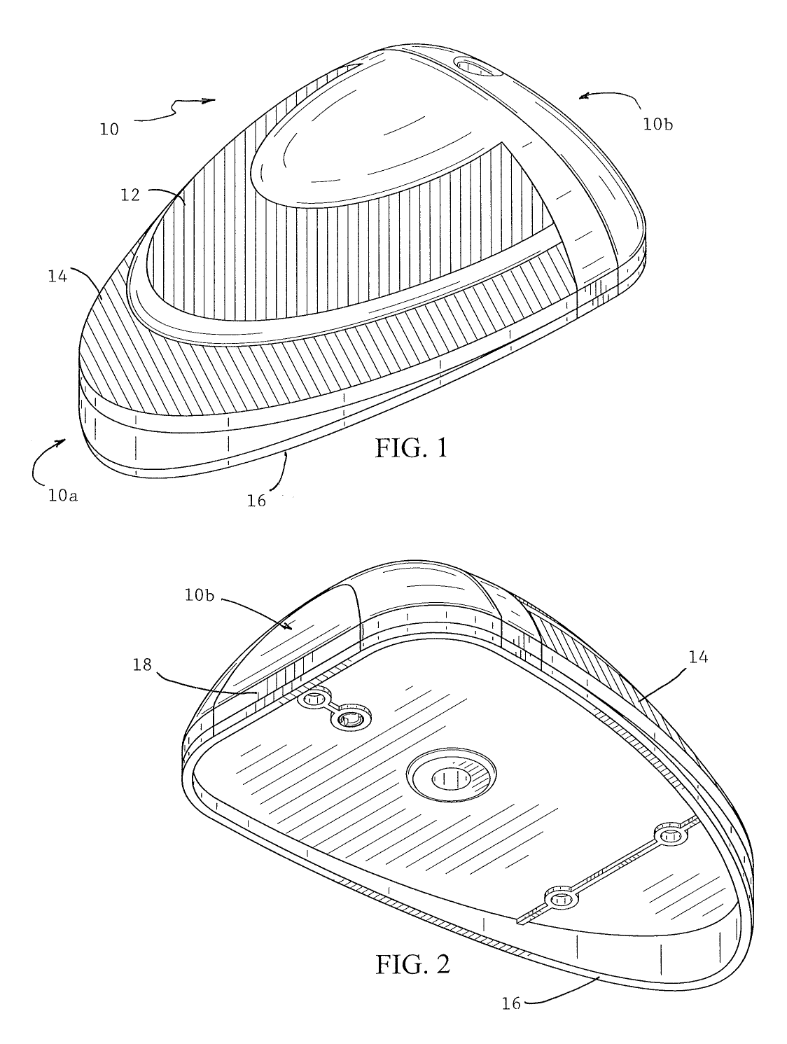

Referring to FIG. 1, a preferred embodiment of a pedestrian motorist assistance (PMA) device 10 is shown in front perspective view having a forward end 10a for facing the front of a vehicle and a rear end 10b. The PMA device is designed as a light beacon assembly to be positioned on a front part of a vehicle where it can be seen by a pedestrian in front of the vehicle. The PMA device has a first light beacon lens 12 to provide light of a red color and is to be electrically coupled to a first sensor for a brake mechanism in the vehicle so as to actuate the red beacon when the brake mechanism is being operated by the driver. The PMA device has a second light beacon lens 14 to provide light of a green color and is to be electrically coupled to a second sensor for a gas-pedal mechanism in the vehicle so as to actuate the green beacon when the gas-pedal mechanism is being operated by the driver. The dual-lens assembly is split horizontally to provide the red light from a top layer (for higher visibility) and the green light from a bottom layer. The PMA assembly has a curved base 16 to be installed on a curved, forward exterior leading edge of the roof of the driver/passenger compartment of automobiles and sport utility vehicles (SUV).

FIG. 2 shows a rear perspective view of the PMA device. The rear end 10b of the assembly includes a connector port 18 for electrical leads to the beacon assembly to be electrically connected to sensors for the brake and gas-pedal mechanisms.

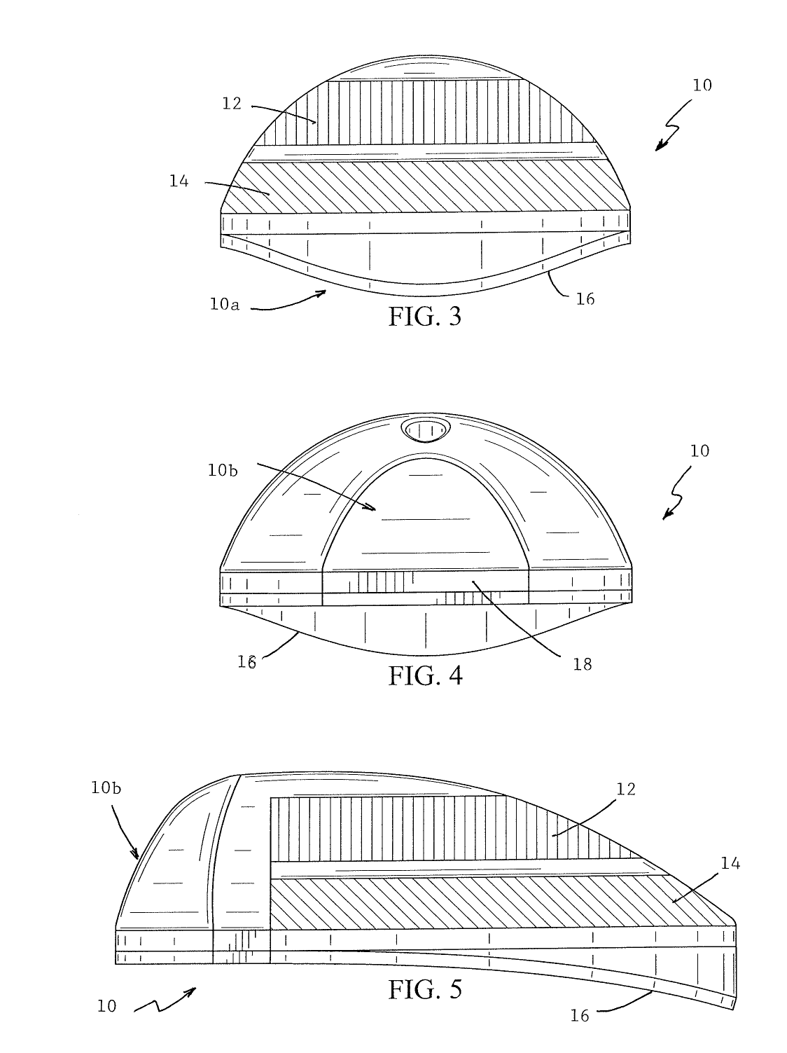

FIG. 3 shows a front view of the PMA device.

FIG. 4 shows a rear view of the PMA device.

FIG. 5 shows a side view of the PMA device.

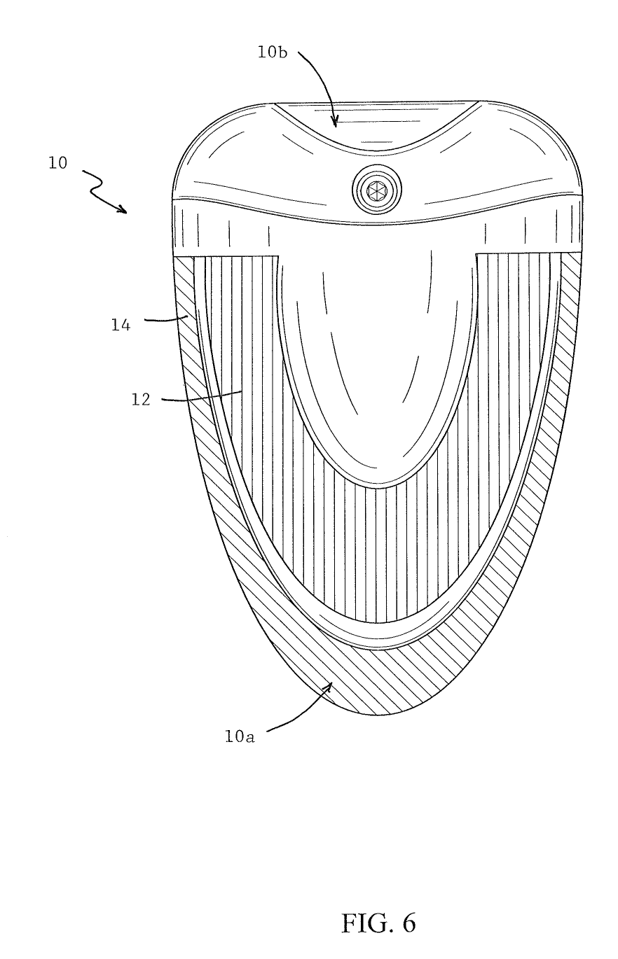

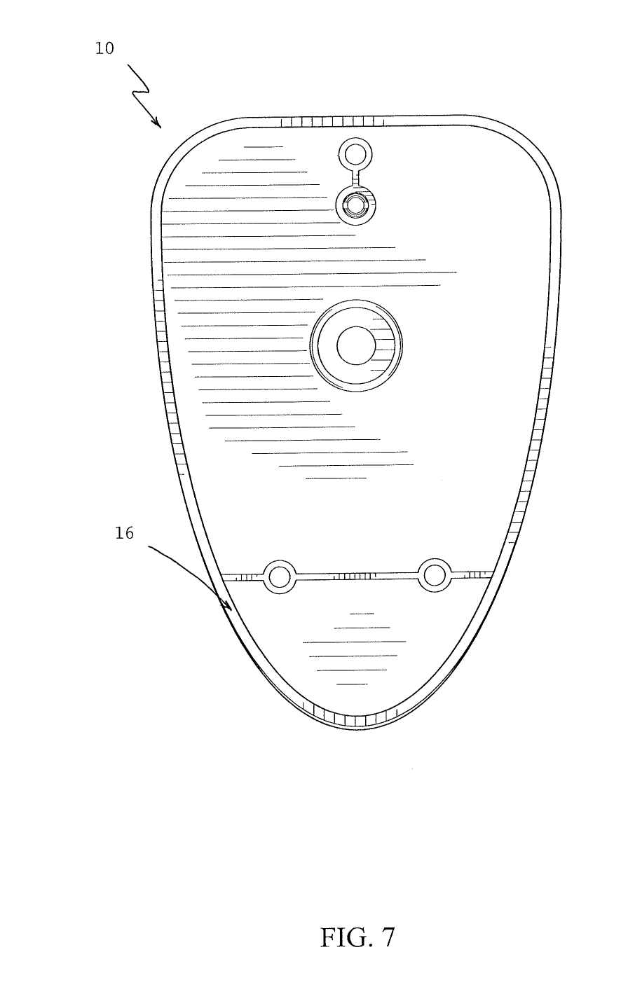

FIG. 6 shows a top view of the PMA device.

FIG. 7 shows a bottom view of the PMA device.

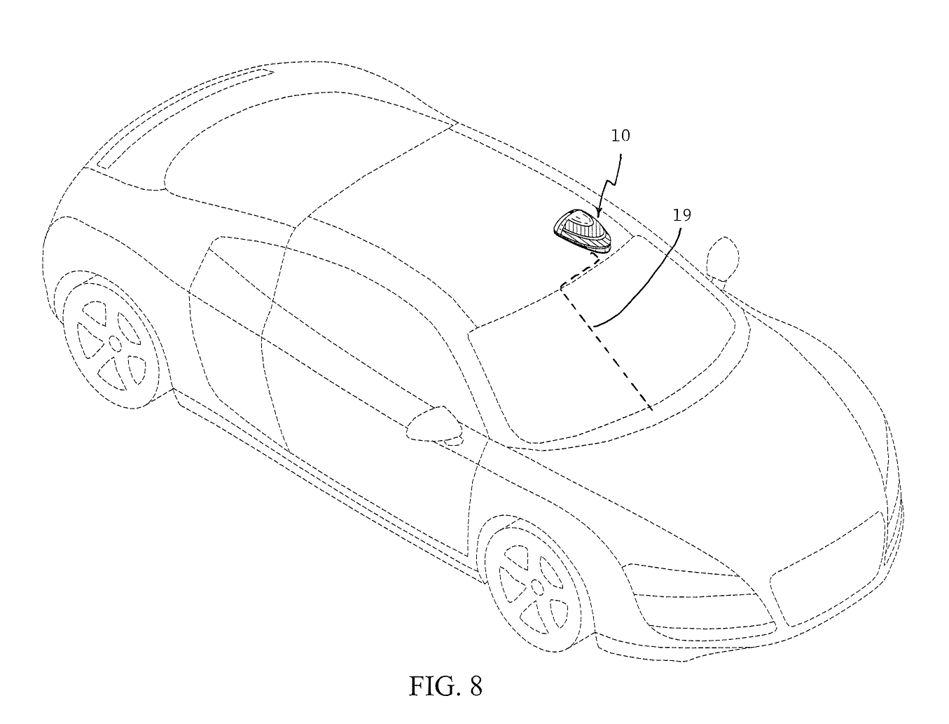

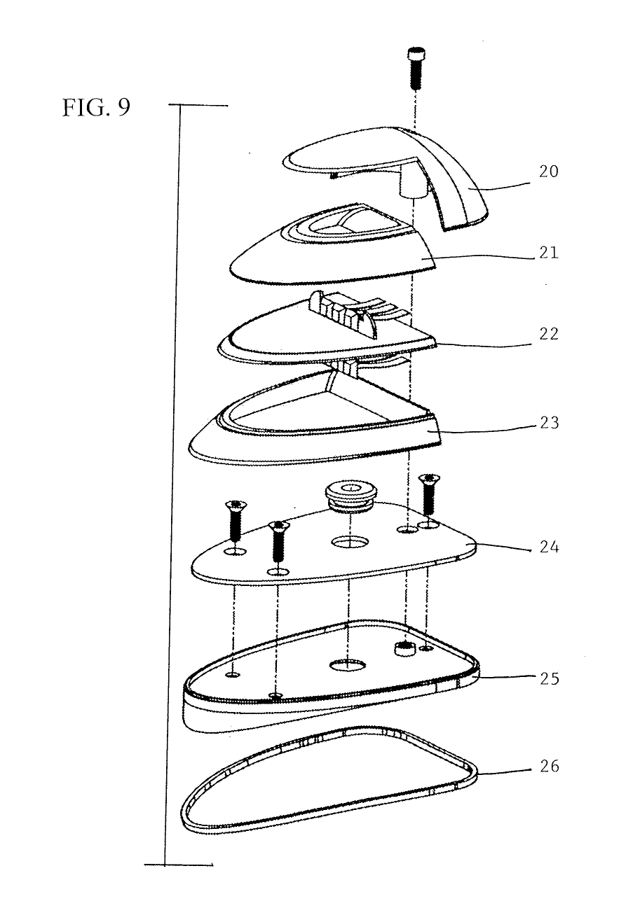

FIG. 8 shows the PMA device 10 in its intended environment of use installed on the front edge of the roof of a driver/passenger compartment of a vehicle. Connecting electrical leads 19 are traced along the front edge of the roof of the vehicle down a part of the windshield and under the hood of the vehicle to connect the beacon assembly 10 to sensors for the brake and gas-pedal mechanisms extending from under the driver/passenger compartment into the engine and undercarriage compartment.

FIG. 9 shows an assembly view of the PMA device comprising a top cover 20, a red lens housing 21, a lens light connector board 22 with upper and lower parts to illuminate the red and green beacons, respectively, a green lens housing 23, a base board 24, a lower housing 25 with curved base edge, and a rubber mounting gasket 26. The electrical components of the lens light connector board 22 are coupled to the sensors for the brake and gas-pedal mechanisms. They may comprise LED 12 VDC, 14 Lumens, marine and waterproof graded bulbs, 3 each per lens. The red beacon LEDs may be coupled to the vehicle's brake pedal sensor (indicating when depressed) while the green beacon LEDs may be coupled to the vehicle's gas-pedal sensor.

Preferred materials and components for the PMA assembly may include the following. The beacon assembly base may be made of hard rubber ½″ thick, measuring 6.0″ L×4.0″ W×1.50″ H. Secured above the base may be the lower housing followed by a metal plate (same dimensions). The area may be recessed to sit flush with the top of the housing without interfering with the lens cover. Above assembly may be secured to the vehicle roof surface by three (3) #10 machine countersunk screws each coupled with a washer and ⅜″ lock-type nut. The two forward #10 mount holes may be drilled approximately 3¼″ rear-to-forward and centered equally through rubber base, lower housing and metal plate. The area may be recessed so that it sits flush with the top of the housing without interfering with the lens cover. Single rear mount hole may also be drilled through same base, housing and plate affixed with #10 screws coupled by washers and ⅜″ lock-type nuts. Atop the metal plate may be the semi-circular green lens, measuring ½″ (H)×2″ (D). The light separator board may be fitted and secured into a slotted area of the lower housing. Mounted atop the light separator board may be the semi-circular red/green lens. The light sources may be 12 VDC, 14 Lumens, marine and waterproof graded LED bulbs. From each bulb may be respective power and ground wiring, totaling 4 each #12 wires, approximately 8′ length. Exit of light wiring may be through a grommet hole (⅜″ ID, 1″ OD, 9/64″ thickness for 11/16″ drill). The insulation and sealing around the holes may be cut in solid panels, allowing for vibration dampening and minimizing abrasions. Insulation Durometer hardness may be 55 A for use indoors and outdoors, and color black. The top cap may be a chrome-plated cover secured by one #10 allen-head screw and lock washer coupled to the lower housing.

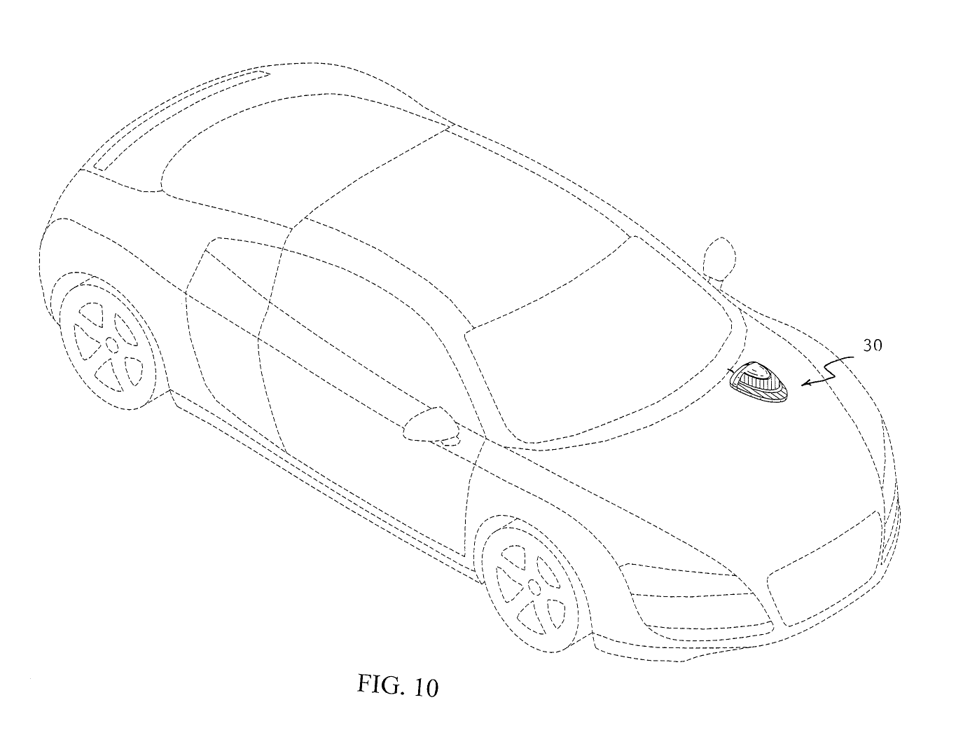

FIG. 10 shows a modified PMA device 30 having a flat base to be installed on the hood of an automobile.

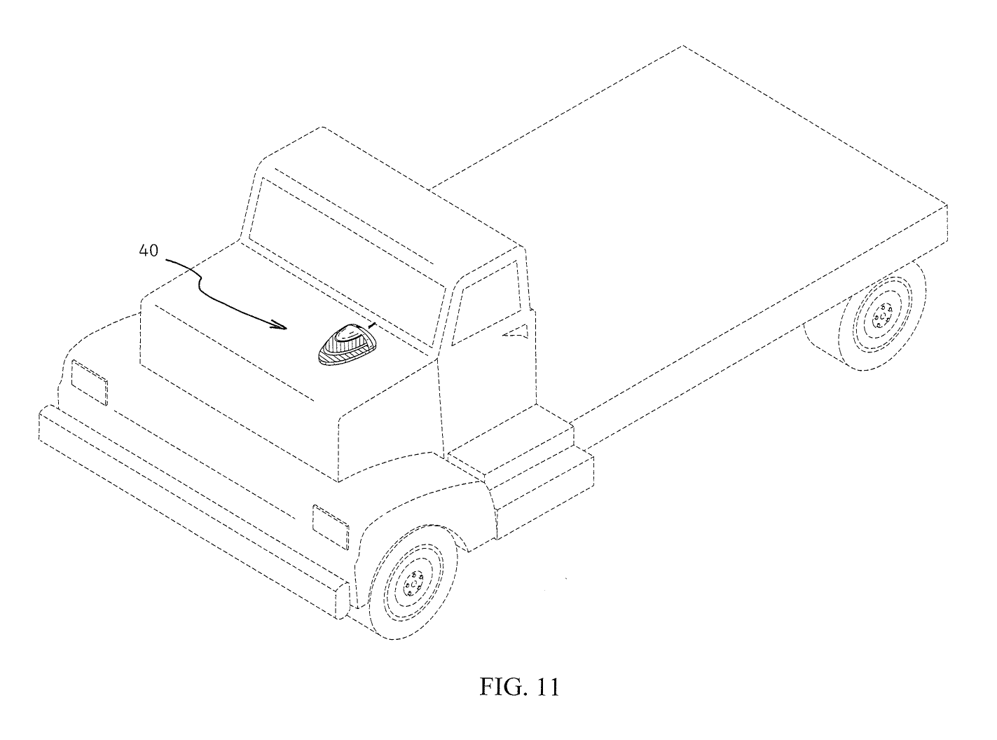

FIG. 11 shows a modified PMA device 40 having a flat base to be installed on the hood of a truck.

Ideally, the installation of PMA devices on vehicles would be recommended by motor vehicle safety organizations and eventually mandated by National Highway Traffic Safety Administration (NHTSA). Prominent motor vehicle safety organizations include advocacy groups such as Mother's Against Drunk Driving (MADD) and the National Council on Alcoholism and Drug Dependence (NCADD).

The PMA device may be modified and/or adapted for use in other environments where providing a positive indication of the intent of the driver is helpful to avoid accidents. When two vehicles with PMA devices are approaching on a narrow two-way street, the PMA red illumination will assist telling the other driver that the driver is yielding to you. PMA red illumination on a vehicle slowing or stopping for a reason (e.g. a pedestrian in a crosswalk, someone/something darting in the street, or an emergency vehicle approaching) will warn other drivers of a possible hazard. If an oncoming vehicle with PMA green illuminated is approaching an intersection where the traffic signal is changing from green light, this indicates the intent of that vehicle to run the yellow or red light, and warns other vehicles to avoid a potential accident. While merging into traffic, a red PMA on a merging vehicle indicates that the driver is yielding to you. If you see in the rear view mirror that a vehicle is approaching at a high rate of speed with PMA green illuminated, you should brace yourself for a rear-end collision. The PMA device can also be used as a vehicle locator, by having a switch in the PMA assembly that receives a signal from the car's remote and causes the PMA device to illuminate.

Many modifications and variations may of course be devised given the above description of preferred embodiments for implementing the principles in the present disclosure. It is intended that all such modifications and variations be considered as within the spirit and scope of this disclosure, as defined in the following claims.

1. A pedestrian motorist assistance device to be mounted on a vehicle so as to be visible from at least a front part thereof, comprising:
a light beacon assembly to be positioned on the front part of the vehicle, having a first light beacon part to provide light of a first color, which is configured to be electrically coupled to a first sensor for a brake mechanism in the vehicle so as to actuate the first light beacon part to illuminate the first color when the brake mechanism is being operated by the driver, and a second light beacon part to provide light of a second color, which is configured to be electrically coupled to a second sensor for a gas-pedal mechanism in the vehicle so as to actuate the second light beacon part to illuminate the second color when the gas-pedal mechanism is being operated by the driver.

2. A pedestrian motorist assistance device according to claim 1, having a curved base to be installed on a curved, forward exterior leading edge of the roof of the driver/passenger compartment of the vehicle.

3. A pedestrian motorist assistance device according to claim 1, having a flat base to be mounted on a flat part of the roof or hood of a utility vehicle.

4. A pedestrian motorist assistance device according to claim 1, configured as a dual-lens assembly split horizontally to provide a red light from a top layer and a green light from a bottom layer.

5. A pedestrian motorist assistance device according to claim 1, configured as a dual-lens assembly comprising a top cover, a red lens housing, a green lens housing, a lens light connector board with upper and lower parts to illuminate red and green lens housings, respectively, a base board for fastening to a part of the vehicle, and a lower cover.

6. A method of using a dual-lens assembly to be mounted on a vehicle so as to be visible from at least a front part thereof, comprising:
using a first light beacon part of the dual-lens assembly to provide light of a first color when a brake mechanism in the vehicle is being operated by the driver, and
using a second light beacon part of the dual-lens assembly to provide light of a second color when a gas-pedal mechanism in the vehicle is being operated by the driver.

7. A method of using a dual-lens assembly according to claim 6, wherein the dual lens assembly is mounted on a front part of the vehicle where it can be seen by a pedestrian in front of the vehicle.

8. A method of using a dual-lens assembly according to claim 6, wherein when two vehicles provided with dual-lens assemblies are approaching, the dual-lens assemblies are used to assist telling the other driver that one driver is yielding.

9. A method of using a dual-lens assembly according to claim 6, wherein when a vehicle provided with dual-lens assembly is slowing or stopping for a reason of a possible hazard, the dual-lens assembly is used to warn other drivers of a possible hazard.

10. A method of using a dual-lens assembly according to claim 6, wherein when a vehicle provided with dual-lens assembly is approaching an intersection or merging into traffic, the dual-lens assembly is used to indicate the intent of the driver of that vehicle to slow or brake or to continue at speed.

11. A method of using a dual-lens assembly according to claim 6, wherein the dual-lens assembly is used as a vehicle locator, by having a switch in the dual-lens assembly to receive a signal from a vehicle's remote control unit and causes the dual-lens assembly to illuminate.
